(19) United States
(12) Patent Application Publication
(10) Pub. No.: US 2008/0087182 A1
(43) Pub. Date: Apr. 17, 2008

(54) Cleaning equipment for a rotary printing press

(75) Inventor: Klaus Hamalainen, Joensuu (FI)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: TECHNOTRANS AG, Sassenberg (DE)

(21) Appl. No.: 11/859,183

(22) Filed: Sep. 21, 2007

(30) Foreign Application Priority Data
Sep. 27, 2006 (DE) 102006046071.5-27

(51) Int. Cl. B41F 35/00

(52) U.S. Cl. 101/425

(57) ABSTRACT

The invention concerns with a cleaning equipment (1) for cleaning at least one guide roll (2) in a rotary printing press that feeds a paper web (3), which has at least one cleaning brush (4) in the range of the guide roll (2) that should be cleaned, which is arranged coaxially to this cleaning equipment (1) in the expansion space, defined by the paper web (3), which possesses a bristle field with helically revolving brushes (5), and the brushes are brought with their bristle field to the guide roll (2) with the purpose of cleaning at least in some areas, during the cleaning process; thereby the cleaning equipment (4) has at least one dirt discharge unit (6), through which the dirt particles or similar could be removed from the guide roll (2) by the means of at least one cleaning brush (4). Cleaning equipment (1) according to the invention is characterized through the fact that the bristle field of at least one cleaning brush (4) has at least two adjacent sub areas (7, 8) with brushes revolving in the opposite direction, which move the dirt particles, removed from the guide roll (2), into these sub areas (7, 8) either to the sub areas of a conjoint dirt discharge unit, which is arranged between the adjacent sub areas of the cleaning brush (7, 8), or respectively to a dirt discharge unit (6), provided sideways to the adjacent sub areas of the cleaning brush (7, 8) at the end faces (cp. FIG. 1).

The invention is concerned with cleaning equipment for cleaning at least one guide roll that feeds a paper web, which has at least one cleaning brush in the range of the guide roll that should be cleaned, which is arranged coaxially to this cleaning equipment in the expansion space, defined by the paper web, which possesses a bristle field with helically revolving bristles and the bristles are brought to the guide roll with the purpose of cleaning with their bristle field, at least during the cleaning process, at least in some areas, thereby the cleaning equipment has at least one dirt discharge unit, through which the dirt particles or similar could be removed from the guide roll by the means of at least one cleaning brush.

In rotary printing presses, in particular those used for printing newspapers, the paper web is fed through a multitude of guide rolls, which serve for web guidance as well as for redirection of the paper web inside of the machine. Thereby the freshly printed paper is fed through such guide rolls, so that a portion of still fresh printing ink can stay adhered to the mentioned guide rolls. Therefore a rough or textured roll surface is already applied to these guide rolls, in order to keep the areas on the roll's surface that come into contact with the paper or the printing ink on the paper as small as possible. However printing ink still remaining on the roll's surface can lead with the time to an undesirable color application onto the subsequent batches of the paper web and therefore to a certain color fog on the newspapers' paper.

In order to prevent this troublesome color fog from occurring excessively, the guide rolls should be cleaned from time to time. Considering that a multitude of such guide rolls is provided in a printing press, it is clear that such cleaning of guide rolls could be associated with not insubstantial expenses.

Therefore cleaning equipment was also created, in which the cleaning of guide rolls with help of paper webs takes place through wiping, depending on the production, for the various web channels. For that the paper webs are saturated on both sides with a cleaning agent prior to entering the printing unit. The wet paper webs are drawn through the machine at a low speed. Brake units stop the guide roll next to different wrapping brackets in different timed intervals and through that constitute the washing process. Thereby the paper web takes the residual color and paper dust from the guide rolls and carries them out of the machine. The locking of the guide rolls occurs repeatedly during the cleaning process, lasting up to several minutes, in order to clean also the whole surface of the guide rolls. In order to dry guide rolls, they are also slowed down repeatedly until they standstill, while the dry paper web passes by. Keep in mind that this cleaning process, conducted by the means of a wet paper web, takes a time period of several minutes and consider that a high-capacity printing unit could run through approximately 100 meters of paper per minute; it is clear that the cleaning process conducted with the aforementioned cleaning equipment could lead to a “mountain of waste” of several 100 meters of paper, whereat this paper waste is saturated with a cleaning agent and soiled with excessive printing ink and therefore should be disposed only as a special waste.

From the DE 38 12 678 C3 cleaning equipment for cleaning of cylindrical circumferential surface in a sheet fed rotary press is already known, which has a cylindrical cleaning brush, which could be led in the area, where sheets are not fed, on the circumferential surface of the cylinder during printing. The cleaning brush known from the cleaning equipment from the DE 38 12 678 C3, which also can possess a bristle field with bristle rows arranged spirally, is located in a suction cone, which has a suction-air connection that reaches beyond the longitudinal extension of the cleaning brush. The aforementioned cleaning equipment, which should provide a grease free sheet transportation for a long duration of action with little set-up time and with a high degree of operational reliability through relatively simple and dependable machine elements, requires a comparatively large space utilization due to its long installation depth in a usually very tight space on the inside of the rotary printing unit.

Therefore a particular challenge exists, to create cleaning equipment of the already mentioned kind, which is characterized through a high cleaning effectiveness and preferably also through a low need of space.

The solution to this task pursuant to the invention for the cleaning equipment of the already mentioned kind implies that the bristle field of at least one cleaning brush has at least two adjacent sub areas with bristles that rotate in the opposite direction, which move the dirt particles, removed from the guide roll in these sub areas, either to the sub areas of a conjoint dirt discharge unit, which is arranged between the adjacent sub areas of the cleaning brush, or respectively to a dirt discharge unit, provided sideways to the adjacent sub areas of the cleaning brush at the end faces.

The cleaning equipment, pursuant to the invention, possesses at least one cleaning brush, bristle field of which has at least two adjacent sub areas with bristles revolving in the opposite direction. Since the bristles in these sub areas rotate helically and since the dirt particle, which are detached by these bristles, should be transported to the dirt discharge unit only through these sub areas and therefore through a relatively short distance, in comparison to the total longitudinal extension of the cleaning brushes, the cleaning brushes of the cleaning equipment, pursuant to the invention, can remove these dirt particles and transport away from the area of the guide roll comparatively easy. Since the cleaning brushes move the detached dirt particles either to the sub areas of a conjoint dirt discharge unit, which is arranged between the adjacent sub areas of the cleaning brush, or respectively to a dirt discharge unit, provided sideways to the adjacent sub areas of the cleaning brush at the end faces, and since therefore the cleaning equipment, pursuant to the invention, makes unnecessary the presence of a suction cone reaching beyond the longitudinal extension of the cleaning brush, the cleaning equipment, pursuant to the invention, is characterized through a small installation depth and therefore through a relatively low need of space. Since the inversely arranged sub areas of the cleaning brushes, which easily detach the dirt particles that are located on the guide roll and can transport them to the adjacent dirt discharge unit on the inside of the cleaning equipment, the cleaning equipment, pursuant to the invention is also characterized through a high cleaning effectiveness.

In order to achieve a constant high cleaning effectiveness on the whole longitudinal extension of the guide roll, it is beneficial, when the both sub areas of the bristle field of at least one cleaning brush possess a longitudinal extension of an approximately identical magnitude and adjoin to each other approximately in the center of the bristle field.

In a beneficial way it is intended that the cleaning brush is mounted so that it can move diagonally to the longitudinal extension of the guide roll and the guide roll is brought under pressure by the means of a pressing force. Since in this suggestion of the invention the cleaning brush is mounted diagonally to the longitudinal extension of the guide roll so it can move and is pressed by the means of a pressing force against the guide roll, the high cleaning effectiveness of the cleaning equipment, pursuant to the invention, is benefited even more.

Since the cleaning brushes can be relatively long compared to the guide roll, it is advisable that the cleaning brushes are mounted in their bristle end faces and/or in the area of the bristle field, so they can move preferably between the sub areas of the cleaning brushes, and/or are brought under pressure by the means of a pressing force. Such cleaning equipment can also be used for large and high-capacity rolling rotary printing units with a relatively long guide roll.

Thereby an especially simple and beneficial form of implementation, pursuant to the invention, plans that at least one pressure spring is provided as a pressing force, which brings under pressure at least one mount of cleaning brushes.

Furthermore it is intended in a beneficial way that the cleaning brushes and the guide roll, assigned to them, have a joint rotary drive. If cleaning brushes and the guide roll assigned to them possess a joint rotary drive, not only the space saving design of the cleaning equipment, pursuant to the invention, will be achieved, but also the cleaning equipment, pursuant to the invention, would be able to clean the guide roll for both: stopped rotary printing unit and during the production, while paper web is running. Since the guide roll with the joint rotary drive is also in a drive connection, the guide roll could be moved and cleaned also during downtime of the rotary printing unit with or without the paper web, which is fed through the guide roll.

The cleaning equipment could also subsequently be mounted very easily to the existing rotary printing units, when the rotary drive is connected with the guide roll through at least one friction wheel, and when the friction wheel is applied preferably to the roll surface of the guide roll.

The high cleaning effectiveness of the cleaning equipment, pursuant to the invention, is benefited even more, when the cleaning brush is driven in the opposite direction from the guide roll, assigned to it.

Thereby an especially simple and space saving form of implementation pursuant to the invention plans that the cleaning brush and the guide roll, assigned to it, have a joint rotary drive.

In order to be able to utilize the cleaning equipment, pursuant to the invention, also for large and high-capacity rotary printing units with relatively long guide rolls, form of implementation, pursuant to the invention, plans that the axle of at least one cleaning brush at its longitudinal extension is additionally supported by the means of at least one axle mount. Thereby it is especially beneficial when at least one axle mount is provided in the parting line between the bristles of the cleaning equipment, pursuant to the invention, which rotate in the opposite direction.

It is especially recommended that the cleaning brush applied to the guide roll, which should be cleaned, is resilient.

A preferred form of implementation pursuant to the invention plans that the cleaning brush is brought in the area of its axle mount by the means of at least one pressure spring, which presses the cleaning brush against the guide roll that should be cleaned.

An especially simple and cost saving form of implementation pursuant to the invention plans that the cleaning equipment has a body, which is produced from an extrusion profile and/or from a metallic or plastic profile.

The cleaning effectiveness of the cleaning equipment, pursuant to the invention, would additionally increase significantly, when the body of the cleaning equipment has an opening alongside, in which the cleaning brushes are mounted so they can rotate.

Especially beneficial is when the opening of the cleaning equipment in its unobstructed interior area is adjusted with a small gap to the outer perimeter of the cleaning bristle.

Further criterions, pursuant to the invention, result from the following description of examples of implementation, pursuant to the invention, in connection with the figures. Hereafter the invention will be explained in detail by means of a preferred example of implementation.

It shows:

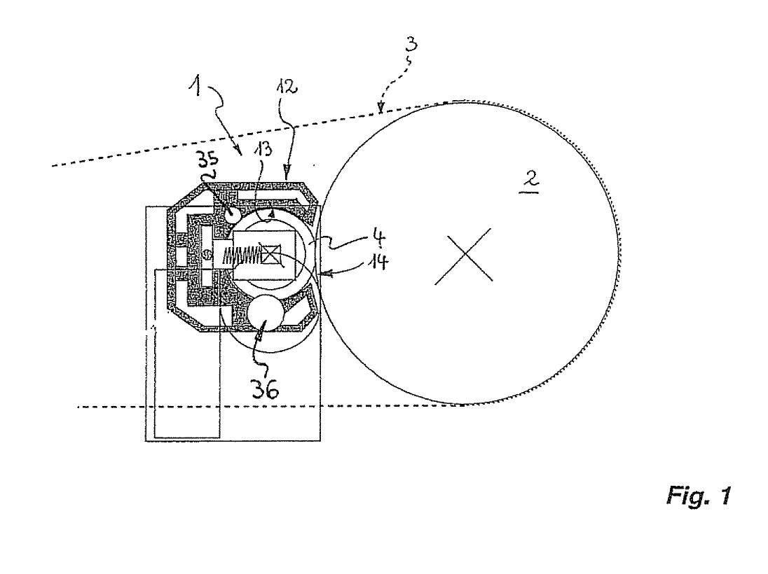

FIG. 1-cleaning equipment for cleaning of a guide roll, which is located in a rotary printing unit, whereat the cleaning equipment is shown here in a cross section,

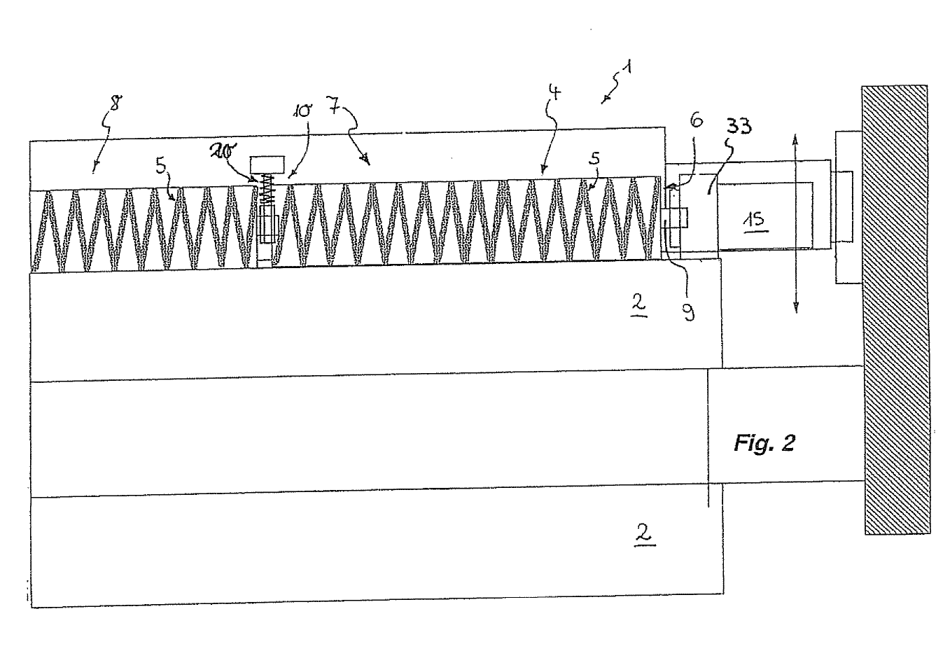

FIG. 2-the cleaning equipment from FIG. 1 in a partial longitudinal cut, whereat the cleaning equipment is presented in the area of the axle mount of its cleaning brush,

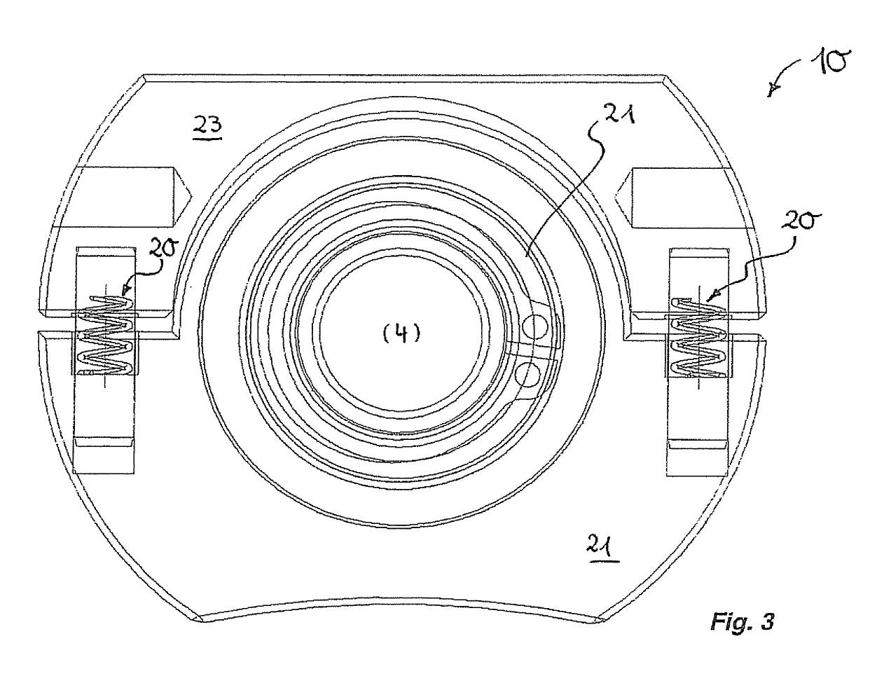

FIG. 3 the axle mount of the cleaning equipment from FIG. 1 and 2, which is intended for the cleaning brush, and

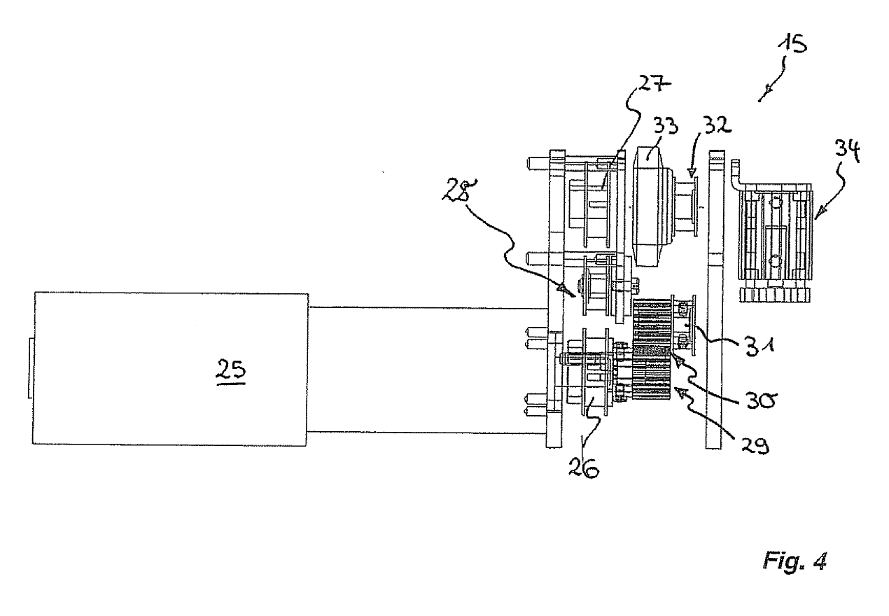

FIG. 4 the cleaning equipment from FIG. 1 through 3 in the area of the joint rotary drive, assigned to the cleaning brush on the one hand and to the guide roll on the other hand.

In FIGS. 1 and 2 cleaning equipment 1 for cleaning of the cylindrical circumferential surface of a guide roll 2 is presented. This guide roll 2 is provided in a roll rotary printing unit, which in other respects will not be shown further, and should feed the paper web 3 into this unit.

In addition the cleaning equipment 1 possesses a cleaning brush 4 that is arranged coaxially to the guide roll 2, which has a bristle field with bristles that are revolving helically. The cleaning brush 4 is arranged in the free space, defined through the paper web 3 and therewith is in the “shadow” of the guide roll 2, which is wrapped around by the paper web 3. During the cleaning process this cleaning brush 4 can be applied to the guide roll 2 with its bristle field with the purpose of cleaning at least in some areas.

The cleaning equipment 1 possesses on both sides of its end faces a dirt discharge unit 6 in each case; also on both sides of its end faces of the cleaning brushes 4 dirt discharge units 6 are provided, through which the detached dirt particles can be removed by the means of the cleaning brushes 4. Since the cleaning equipment 1 makes the suction cone, reaching through the longitudinal extension of the cleaning brush 4, and since the cleaning equipment 1 presented here has instead a dirt discharge unit 6 at its end faces in each case, the cleaning equipment 1 is characterized through a low installation depth and therewith through a relatively low need of space. In order to transport the dirt particles in the cleaning equipment 1 in direction of the neighboring dirt discharge unit 6, the cleaning brush 4 has two sub areas 7 and with the bristles, rotating in the opposite direction, the dirt particles, which are removed from the guide roll 2 in these sub areas 7, 8, are moved to the adjacent dirt discharge unit 6. In FIG. 2 only one dirt discharge unit 6 can be seen out of dirt discharge units 6, provided on both sides. Since the sub areas 7, 8 of the inverse cleaning brush 4 can easily break off the dirt particles, located on the guide roll 2 and in the insides of the cleaning equipment 1, and transport them to the neighboring dirt discharge unit 6, the cleaning equipment 1 also is characterized through a good cleaning effectiveness.

From comparing FIGS. 1 and 2 it is clear that both sub areas 7, 8 of the bristle field of the cleaning brush 4 possess an approximately equal longitudinal extension and adjoin to each other approximately in the center of the bristle field. The axle 9 of the cleaning brushes 4 is supported at their both axle end faces and additionally also at their longitudinal extension, preferably approximately in the center, by the means of an axle mount 10. Thereby the cleaning brush 4 in the area of its axle mount 10 is brought by the means of at least one pressure spring 20, which presses the cleaning brush 4 against the guide roll 2 that should be cleaned.

In FIG. 3 the cleaning equipment 1 is presented in the area of its one axle mount 10. In FIG. 3 it is important to recognize that the cleaning brush 4 is mounted at its bristle end faces and preferably also in the area of the bristle field between the sub areas of the cleaning brushes 7, 8, so that it can move. For that purpose the cleaning brush is held in a cleaning brush mount 21, which is movable against the guide roll by the means of a pressing force. Thereby at least one pressure spring 20 is provided as a pressing force, which is supported on a mount retainer 23 and brings the cleaning brush mount 21.

The cleaning equipment 1 possesses a body 12, which is produced from an extrusion profile. The body 12 has an opening 13, which with its unobstructed cross section is adjusted with a small gap to the outer perimeter of the cleaning brush 4. The opening is located alongside, whereby the bristles 5 of the cleaning brush 4 protuberate ready for use from the alongside opening 14 of the extrusion profiles 12.

In FIG. 2 it is implied that the cleaning brush 4 and guide roll 2 that should be cleaned by it possess a joint rotary drive 15. This rotary drive 15 is preferably designed so that the guide roll 2 on the one hand and the cleaning roll 4 on the other hand rotate in opposite directions.

In FIG. 4 the joint rotary drive 15 is presented in detail, which is assigned to the guide roll 2 on the one hand and to the cleaning roll 4 on the other hand. This rotary drive 15 possesses a driving motor 25, which the driving axle is connected with the cleaning roll 4 through a belt transmission, which is indicated through the drive wheels 26, 27. A belt tightener 28 is assigned to this belt transmission, which takes care of drive belts, which are constantly tense, despite the cleaning brush 4, mounted so that they can move. The rotation of the guide roll 2 in the opposite direction is achieved by the means of two gears 29, 30, which are connected with a friction wheel 33 through another belt transmission, which is indicated through drive wheels 31, 32. The friction wheel 33 is applied to the roll surface of the guide roll 2, which will not be discussed here further. In FIG. 4 it is implied that the cleaning equipment 1 can be applied to the guide roll 2 with help of at least one pneumatic cylinder 34 or can be brought to the guide roll from a distance.

In FIG. 1 is implied that the body 12 of the cleaning equipment 1 can possess a cleaning agent dispensing pipe 35, which reaches preferably through the cleaning brush 4, which allows application by spraying on the cleaning brush 4. In the lower area of the body 12 cleaning agent drainage 36 is provided, in which the used cleaning agent can be collected and discharged from the body 12.

The cleaning equipment 1 presented here is characterized through a low need of space for it, as well as through its high cleaning effectiveness.

1.-11. (canceled)

12. Cleaning equipment for cleaning at least one guide roll in a rotary printing press that feeds a paper web, which has at least one cleaning brush in the range of the guide roll that should be cleaned, which is arranged coaxially to this cleaning equipment in the expansion space, defined by the paper web which possesses a bristle field with helically revolving brushes and the brushes are brought with their bristle field to the guide roll with the purpose of cleaning at least in some areas, during the cleaning process; thereby the cleaning equipment has at least one dirt discharge unit, through which the dirt particles could be removed from the guide roll by the means of at least one cleaning brush, wherein the bristle field of at least one cleaning brush has at least two adjacent sub areas with brushes revolving in the opposite direction, which move the dirt particles, removed from the guide roll, into these sub areas either to the sub areas of a conjoint dirt discharge unit, which is arranged between the adjacent sub areas of the cleaning brush or respectively to a dirt discharge unit, provided sideways to the adjacent sub areas of the cleaning brush at the end faces.

13. Cleaning equipment pursuant to claim 1 wherein both sub areas of the bristle field of at least one cleaning bristle possess an approximately equal longitudinal extension and adjoin to each other approximately in the center of the bristle field.

14. Cleaning equipment pursuant to claim 1, wherein the cleaning bristle is mounted so it could be moved diagonally to the longitudinal extension of the guide roll and the guide roll is brought under pressure by the means of a pressing force.

15. Cleaning equipment pursuant to one of claim 1, wherein the cleaning bristle is mounted so it could be moved at its bristle end faces and/or in the area of the bristle field preferably between sub areas of the cleaning bristles and/or is brought under pressure by the means of a pressing force.

16. Cleaning equipment pursuant to one of claim 1, wherein at least one pressure spring is provided as a pressing force, which is brought under pressure to at least one cleaning bristles mount.

17. Cleaning equipment pursuant to one of claim 1, wherein the cleaning bristle and the guide roll assigned to it have a joint rotary drive.

18. Cleaning equipment pursuant to one of claim 1, wherein the rotary drive is in connection with the guide roll through at least one friction wheel, and that the friction wheel is brought preferably to the surface of the guide roll.

19. Cleaning equipment pursuant to one of claim 1, wherein the cleaning bristle is rotary drivable in the opposite direction, compared to the guide roll assigned to it.

20. Cleaning equipment pursuant to one of claim 1, wherein the cleaning equipment has a body that is produced from an extrusion profile and/or from a metallic or plastic profile.

21. Cleaning equipment pursuant to one of claim 1, wherein the body of the cleaning equipment has an opening located alongside, in which the cleaning bristle is mounted so it could rotate.

22. Cleaning equipment pursuant to one of claim 1, wherein the opening with its unobstructed inner perimeter is adjusted with a small gap to the outer perimeter of the cleaning bristle.
